(19) United States
(12) Patent Application Publication
(10) Pub. No.: US 2012/0115047 A1
(43) Pub. Date: May 10, 2012

(54) POSITIVE ELECTRODE FOR LITHIUM AIR BATTERY, METHOD OF PREPARING THE SAME, AND LITHIUM AIR BATTERY EMPLOYING THE POSITIVE ELECTRODE

(75) Inventors: Sang-bok Ma, Seoul (KR); Young-gyoon Ryu, Suwon-si (KR); Dong-min Im, Seoul (KR); Victor Roev, Suwon-si (KR); Dong-joon Lee, Seoul (KR)

(73) Assignee: Samsung Electronics Co., Ltd., Suwon-si (KR)

(21) Appl. No.: 13/100,390

(22) Filed: May 4, 2011

(30) Foreign Application Priority Data
Nov. 5, 2010 (KR) 10-2010-0109784

(51) Int. Cl. H01M 12/06; H01M 4/90; H01M 4/88; H01M 8/22

(52) U.S. Cl. 429/405; 252/182.1

(57) ABSTRACT

A lithium air battery having high energy efficiency and high capacity due to improving stability by using oxygen as a positive active material includes using a catalyst for a redox reaction of oxygen. The catalyst includes manganese oxide including a transition metal.

### CROSS-REFERENCE TO RELATED APPLICATION

This application claims the benefit of Korean Patent Application No. 10-2010-0109784, filed on Nov. 5, 2010 in the Korean Intellectual Property Office, the disclosure of which is incorporated herein by reference.

### BACKGROUND

1. Field

Aspects of the present disclosure relate to a positive electrode for a lithium air battery, a method of preparing the same, and a lithium air battery employing the positive electrode, and more particularly, to a positive electrode for a lithium air battery including a catalyst having excellent stability, a method of preparing the same, and a lithium air battery having high energy efficiency and capacity.

2. Description of the Related Art

Lithium air batteries include a negative electrode in which lithium ions are intercalatable and deintercalatable, a positive electrode including oxygen as a positive active material and a catalyst for a redox reaction of oxygen, and a lithium ion conductive medium between the positive electrode and the negative electrode. Lithium air batteries have a theoretical energy density of 3000 Wh/kg or greater which is about 10 times greater than that of lithium ion batteries. In addition, lithium air batteries are environmentally safe and have better stability than lithium ion batteries.

Lithium air batteries include a positive electrode using oxygen in the air as an active material, and thus may be charged and discharged by oxidation and reduction of oxygen in the positive electrode. In general, the positive electrode of a lithium air battery includes a current collector, a conductive material (for example, a carbonaceous material), and a catalyst using the carbonaceous material as a support.

A catalyst is used in a positive electrode of a lithium air battery to improve charge/discharge efficiency of the lithium air battery. It is known that a manganese dioxide catalyst reduces overvoltage during an oxygen evolution reaction (OER), that is, oxidation of oxygen while charging. In other words, Li₂O is formed in a tunnel structure of manganese dioxide and moves from a carbonaceous material support to the manganese dioxide without an energy barrier when oxygen is generated during charging, thereby facilitating the generation of oxygen.

However, since lithium ions may be deintercalated from and intercalated into the manganese dioxide structure while a lithium air battery is charged and discharged, a Jahn-Teller distortion phenomenon caused by Mn³⁺ ions may occur; therefore the manganese dioxide catalyst degrades. In addition, since manganese dioxide is dissolved as Mn²⁺ ions at a high voltage or low voltage, capacity and energy efficiency of a lithium air battery may decrease.

### SUMMARY

A positive electrode for a lithium air battery including a catalyst having excellent stability is provided according to an aspect of the invention.

A method of preparing a positive electrode for a lithium air battery including a catalyst having excellent stability is provided according to an aspect of the invention.

A lithium air battery having high energy efficiency and capacity is provided according to an aspect of the invention.

According to an aspect of the present invention, a positive electrode for a lithium air battery includes oxygen as a positive active material and a catalyst for a redox reaction of oxygen, where the catalyst includes manganese oxide including at least one transition metal selected from the group consisting of zinc (Zn), cobalt (Co), iron (Fe), copper (Cu), and nickel (Ni).

According to an aspect of the invention, the manganese oxide including the transition metal may be represented by Formula 1 below:

MₓMn_{y}O_{z} Formula 1

where M includes at least one metal selected from the group consisting of Zn, Co, Fe, Cu, and Ni, and 0<x<1, 0<y<1, 0<z<5, and x+y=1.

According to an aspect of the invention, the catalyst may include manganese oxide including nickel (Ni).

According to an aspect of the invention, the manganese oxide including the transition metal may include one mixed oxide selected from the group consisting of nickel manganese oxide (NiₓMn_{y}O_{z}), nickel zinc manganese oxide ((NiZn)ₓMn_{y}O_{z}), nickel cobalt manganese oxide ((NiCo)ₓMn_{y}O_{z}), nickel iron manganese oxide ((NiFe)ₓMn_{y}O_{z}), nickel copper manganese oxide ((NiCu)ₓMn_{y}O_{z}), nickel zinc cobalt manganese oxide ((NiZnCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), nickel cobalt iron copper manganese oxide ((NiCoFeCu)ₓMn_{y}O_{z}), and nickel zinc cobalt iron copper manganese oxide ((NiZnCoFeCu)ₓMn_{y}O_{z}).

According to an aspect of the invention, the manganese oxide including nickel (Ni) may be represented by Formula 2 below:

NiₓMn_{y}O₂ Formula 2

where 0<x<1, 0<y<1, and x+y=1.

According to an aspect of the invention, the catalyst may include amorphous manganese oxide including a transition metal.

According to an aspect of the invention, the catalyst may include manganese oxide including a transition metal and the catalyst may have an average particle diameter in the range of about 10 to about 70 nm.

According to an aspect of the invention, the amount of the catalyst may be in the range of about 0.1 to about 80% by weight based on the total weight of the positive electrode.

According to an aspect of the invention, the positive electrode for the lithium air battery may further include a carbonaceous material and a binder.

According to an aspect of the invention, the positive electrode may include about 0.1 to about 77.1% by weight of the catalyst, about 20 to about 97% by weight of the carbonaceous material, and about 2.9 to about 20% by weight of the binder based on the total weight of the positive electrode.

According to another aspect of the present invention, a method of preparing a positive electrode for a lithium air battery includes: (a) providing a transition metal on a carbonaceous material by contacting the carbonaceous material with an alcohol solution saturated with a transition metal salt; and (b) providing manganese oxide including the transition metal by contacting the carbonaceous material on which the transition metal is adsorbed with a manganese oxide precursor-aqueous solution.

According to an aspect of the invention, the alcohol solution of operation (a) may be a solution of a C1-C20 alcohol.

According to an aspect of the invention, the alcohol solution of operation (a) may further include water.

According to an aspect of the invention, the transition metal salt of operation (a) may include at least one salt selected from the group consisting of zinc sulfate, zinc nitrate, zinc chloride, zinc acetate, cobalt sulfate, cobalt nitrate, cobalt chloride, cobalt fluoride, cobalt acetate, iron sulfate, iron nitrate, iron chloride, copper sulfate, copper nitrate, copper chloride, copper acetate, nickel sulfate, nickel nitrate, nickel chloride, nickel fluoride, and nickel acetate.

According to an aspect of the invention, the transition metal salt of operation (a) may include at least one salt selected from the group consisting of nickel sulfate, nickel nitrate, nickel chloride, nickel fluoride, and nickel acetate.

According to an aspect of the invention, the manganese oxide precursor of operation (b) may include at least one compound selected from the group consisting of LiMnO₄, NaMnO₄ and KMnO₄.

According to another aspect of the present invention, a lithium air battery includes a negative electrode in which lithium ions are intercalatable and deintercalatable; a nonaqueous electrolyte; and a positive electrode, where the positive electrode includes oxygen as a positive active material and a catalyst for a redox reaction of oxygen, where the catalyst includes manganese oxide including at least one transition metal selected from the group consisting of zinc (Zn), cobalt (Co), iron (Fe), copper (Cu), and nickel (Ni).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a scanning electron microscopic (SEM) image of a positive electrode for a lithium air battery that does not include a catalyst;

FIG. 2 is a SEM image of a positive electrode for a lithium air battery that includes manganese oxide including nickel (Ni) according to Preparation Example 1;

FIG. 3 schematically shows the structure of a lithium air battery according to an embodiment of the present invention; and

FIG. 4 is a graph illustrating characteristics of lithium air batteries measured according to Evaluation Example 1.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a positive electrode for a lithium air battery, a method of preparing the same, and a lithium air battery using the positive electrode will be described.

One embodiment provides a positive electrode for a lithium air battery including oxygen as a positive active material and a catalyst for a redox reaction of oxygen. The catalyst includes manganese oxide including at least one transition metal selected from the group consisting of zinc (Zn), cobalt (Co), iron (Fe), copper (Cu), and nickel (Ni).

The lithium air battery is a battery including a positive electrode in which oxygen in the air is used as an active material. The lithium air battery may be charged and discharged by oxidation and reduction of oxygen in the positive electrode.

The positive electrode for a lithium air battery may include a catalyst for a redox reaction of oxygen. For example, the catalyst for a redox reaction of oxygen may be a noble metal catalyst such as platinum (Pt), gold (Au), silver (Ag), palladium (Pd), ruthenium (Ru), rhodium (Rh), and osmium (Os); an oxide catalyst such as manganese oxide, iron oxide, cobalt oxide, and nickel oxide; or an organometallic catalyst such as cobalt phthalocyanine.

The lithium air battery may use an aqueous electrolyte or a nonaqueous electrolyte as an electrolyte. If the lithium air battery uses a nonaqueous electrolyte, a reaction mechanism is as follows as in Reaction Scheme 1 below.

4Li+O₂ [symbol] 2Li₂O E°=2.91 V

2Li+O₂ [symbol] Li₂O₂ E°=3.10 V Reaction Scheme 1

That is, during discharging, lithium generated in a negative electrode reacts with oxygen of a positive electrode to generate lithium oxide, and oxygen is reduced (oxygen reduction reaction: ORR). On the other hand, during charging, the lithium oxide is reduced, and oxygen is generated by oxidation (oxygen evolution reaction: OER).

In this regard, overvoltage caused by energy used for oxidation/reduction of oxygen deducts considerably from the theoretical charge/discharge voltage. Thus, the actual charge/discharge voltage is less than the theoretical charge/discharge voltage, thereby reducing energy efficiency of the lithium air battery.

For example, if a positive electrode including a carbonaceous material without a catalyst is used, the charge voltage is 4.5 V, and the discharge voltage is 2.5 V. However, if a positive electrode including manganese dioxide as a catalyst is used, the charge voltage is 4.0 V, and the discharge voltage is 2.5 V. That is, if the theoretical reference voltage is 3.0 V, overvoltage during charging when the positive electrode includes manganese dioxide as a catalyst may be less than that by about 0.5 V when the positive electrode includes the carbonaceous material without a catalyst.

However, as the lithium air battery is charged and discharged, lithium ions are intercalatable and deintercalatable into the manganese dioxide structure, so that Mn ions of the manganese dioxide cannot be maintained as Mn⁴⁺ ions and are changed into Mn³⁺ since LiMnO₂ is generated. Thus, a Jahn-Teller distortion phenomenon may occur. Furthermore, Mn³⁺ ions may become Mn²⁺ ions at a high voltage or low voltage, and thus a melting phenomenon may occur. Accordingly, stability of the catalyst may deteriorate, and capacity and energy efficiency of the lithium air battery may be reduced.

The catalyst may include manganese oxide including at least one transition metal selected from the group consisting of zinc (Zn), cobalt (Co), iron (Fe), copper (Cu), and nickel (Ni).

The manganese oxide including the transition metal may be represented by Formula 1 below.

MₓMn_{y}O_{z} Formula 1

In Formula 1, M includes at least one metal selected from the group consisting of Zn, Co, Fe, Cu, and Ni, and 0<x<1, 0<y<1, 0<z<5, and x+y=1. For example, 0<z<3, or z=2.

The combination of manganese oxide including the transition metal that is included within the catalyst may be zinc manganese oxide (ZnₓMn_{y}O_{z}), cobalt manganese oxide (CoₓMn_{y}O_{z}), iron manganese oxide (FeₓMnyO_{z}), copper manganese oxide (CuₓMn_{y}O_{z}), nickel manganese oxide (NiₓMn_{y}O_{z}), zinc cobalt manganese oxide ((ZnCo)ₓMn_{y}O_{z}), zinc iron manganese oxide ((ZnFe)ₓMn_{y}O_{z}), zinc copper manganese oxide ((ZnCu)ₓMn_{y}O_{z}), nickel zinc manganese oxide ((NiZn)ₓMn_{y}O_{z}), iron cobalt manganese oxide ((FeCo)ₓMn_{y}O_{z}), copper cobalt manganese oxide ((CuCo)ₓMn_{y}O_{z}), nickel cobalt manganese oxide ((NiCo)ₓMn_{y}O_{z}), copper iron manganese oxide ((CuFe)ₓMn_{y}O_{z}), nickel iron manganese oxide ((NiFe)ₓMn_{y}O_{z}), nickel copper manganese oxide ((NiCu)ₓMn_{y}O_{z}), zinc iron cobalt manganese oxide ((ZnFeCo)ₓMn_{y}O_{z}), zinc iron copper manganese oxide ((ZnFeCu)ₓMn_{y}O_{z}), nickel zinc cobalt manganese oxide ((NiZnCo)ₓMn_{y}O_{z}), iron copper cobalt manganese oxide ((FeCuCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), zinc cobalt iron copper manganese oxide ((ZnCoFeCu)ₓMn_{y}O_{z}), nickel cobalt iron copper manganese oxide ((NiCoFeCu)ₓMn_{y}O_{z}), or nickel zinc cobalt iron copper manganese oxide ((NiZnCoFeCu)ₓMn_{y}O_{z}). In particular, the manganese oxide including the transition metal may be zinc manganese oxide (ZnₓMn_{y}O_{z}), cobalt manganese oxide (CoₓMn_{y}O_{z}), iron manganese oxide (FeₓMn_{y}O_{z}), copper manganese oxide (CuₓMn_{y}O_{z}), nickel manganese oxide (NiₓMn_{y}O_{z}), nickel zinc manganese oxide ((NiZn)ₓMn_{y}O_{z}), nickel cobalt manganese oxide ((NiCo)ₓMn_{y}O_{z}), nickel iron manganese oxide ((NiFe)ₓMn_{y}O_{z}), nickel copper manganese oxide ((NiCu)ₓMn_{y}O_{z}), nickel zinc cobalt manganese oxide ((NiZnCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), nickel cobalt iron copper manganese oxide ((NiCoFeCu)ₓMn_{y}O_{z}), or nickel zinc cobalt iron copper manganese oxide ((NiZnCoFeCu)ₓMn_{y}O_{z}). More particularly, the manganese oxide including the transition metal may be zinc manganese oxide (ZnₓMn_{y}O_{z}), cobalt manganese oxide (CoₓMn_{y}O_{z}), iron manganese oxide (FeₓMn_{y}O_{z}), copper manganese oxide (CuₓMn_{y}O_{z}), or nickel manganese oxide (NiₓMn_{y}O_{z}).

In the manganese oxide including the transition metal, the transition metal of the manganese oxide reacts with lithium ions so that the oxidation state of the Mn of the manganese dioxide may be maintained to be Mn⁴⁺, and thus the Jahn-Teller distortion caused by Mn³⁺ may be prevented during charging and discharging. Thus, the stability of the catalyst may be improved.

According to an aspect, the catalyst may include manganese oxide including nickel (Ni). For example, the catalyst may include one mixed oxide selected from the group consisting of nickel manganese oxide (NiₓMn_{y}O_{z}), nickel zinc manganese oxide ((NiZn)ₓMn_{y}O_{z}), nickel cobalt manganese oxide ((NiCo)ₓMn_{y}O_{z}), nickel iron manganese oxide ((NiFe)ₓMn_{y}O_{z}), nickel copper manganese oxide ((NiCu)ₓMn_{y}O_{z}), nickel zinc cobalt manganese oxide ((NiZnCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), nickel cobalt iron copper manganese oxide ((NiCoFeCu)ₓMn_{y}O_{z}), and nickel zinc cobalt iron copper manganese oxide ((NiZnCoFeCu)ₓMn_{y}O_{z}).

For example, the manganese oxide including Ni may be represented by Formula 2 below.

NiₓMn_{y}O₂ Formula 2

In Formula 2, 0<x<1, 0<y<1, and x+y=1.

In the manganese oxide including Ni, Ni first reacts with lithium ions to maintain the oxidation state of Mn of the manganese dioxide to Mn⁴⁺, and thus the stability of the catalyst may be improved. The molar ratio of Ni:Mn may be in the range of about 1:0.1 to about 1:1, but is not limited thereto. For example, the molar ratio of Ni:Mn may be in the range of 1:0.1 to 1:0.9. For another example, the molar ratio of Ni:Mn may be in the range of 1:0.1 to 0.8. For yet another example, the molar ratio of Ni:Mn may be in the range of 1:0.1 to 1:0.7. Since the amount of Mn³⁺ varies according to the oxidation state and the number of the transition metal substituting Mn, the molar ratio of Ni:Mn may be within the range described above in order to reduce the amount of Mn³⁺ and improve the stability of Mn⁴⁺.

The catalyst may include an amorphous manganese oxide including a transition metal. The manganese oxide including the transition metal may have a crystalline structure including a spinel type structure, a layered structure, or an amorphous structure. The catalyst having the structure described above is stable and the Jahn-Teller distortion phenomenon is reduced, and thus lifespan may be increased.

In the catalyst, the average particle diameter of the manganese oxide including the transition metal may be in the range of about 10 to about 70 nm. In particular, the average particle diameter of the manganese oxide may be in the range of about 10 to about 60 nm. More particularly, the average particle diameter of the manganese oxide may be in the range of about 10 to about 50 nm.

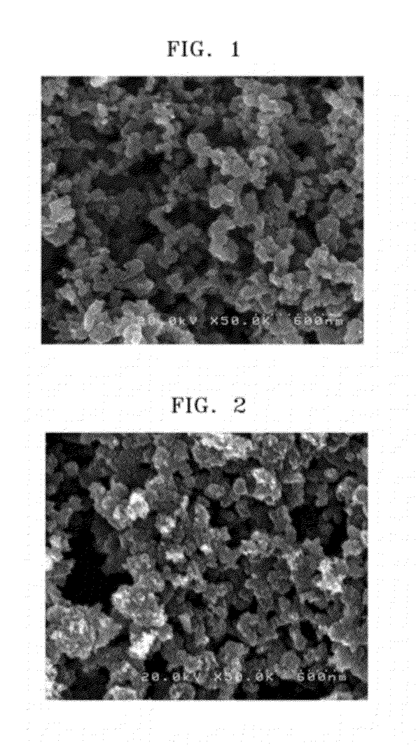

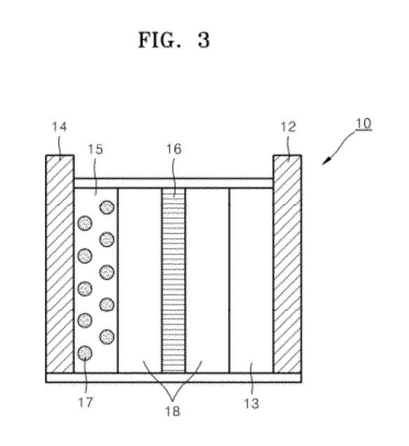

FIG. 1 is a scanning electron microscopic (SEM) image of a positive electrode for a lithium air battery that does not include a catalyst. FIG. 2 is an SEM image of a positive electrode for a lithium air battery that includes a manganese oxide including nickel (Ni) according to Preparation Example 1.

Referring to FIGS. 1 and 2, the average particle diameter of the positive electrode for a lithium air battery not including a catalyst shown in FIG. 1 is about 100 nm. The average particle diameter of the positive electrode for a lithium air battery including the manganese oxide including Ni shown in FIG. 2 is also about 100 nm, and Ni is doped on a carbonaceous material. The positive electrode including the manganese oxide including Ni and having the average particle diameter described above may maintain morphology and have a high catalytic function.

The positive electrode may include about 0.1 to about 80% by weight of the catalyst based on the total weight of the positive electrode. If the amount of the catalyst is within this range, the capacity of the lithium air battery may be maintained, and the catalytic function may be stably performed.

The positive electrode may further include a carbonaceous material and a binder.

The carbonaceous material may have conductivity. The carbonaceous material may function as a support of the catalyst and may or may not be porous. In particular, the carbonaceous material may be porous. In addition, the average particle diameter may be in the range of about 2 nm to about 1 μm. In particular, the average particle diameter may be in the range of about 2 nm to about 100 nm. The specific surface area of the carbonaceous material may be 10 m²/g or greater based on BET analysis. In particular, the specific surface area of the carbonaceous material may be 50 m²/g or greater, or even more particularly, the specific surface area of the carbonaceous material may be 100 m²/g or greater.

If the average particle diameter and the specific surface area of the carbonaceous material are within the ranges described above, the contact area with oxygen increases, and the charge/discharge capacity of the lithium air battery is improved, and thus, a lithium air battery having a high capacity may be prepared.

The carbonaceous material may be carbon black, graphite, graphene, activated carbon, carbon fiber, or the like. In particular, the carbonaceous material may include carbon nanoparticles, mesoporous carbon, carbon nanotubes, carbon nanofibers, carbon nanosheets, carbon nanorods, or the like.

The binder may be polyvinylidene fluoride (PVdF), polytetrafluoroethylene (PTFE), or the like. The positive electrode may include about 0.1 to about 77.1% by weight of the catalyst, about 20 to about 97% by weight of the carbonaceous material, and about 2.9 to about 20% by weight of the binder based on the total weight of the positive electrode. If the positive electrode includes the carbonaceous material and the binder having the amounts within the ranges described above, the carbonaceous material is physically attached to maintain the capacity of the lithium air battery and stability of the catalyst.

Another embodiment provides a method of preparing a positive electrode for a lithium air battery, the method including: (a) providing a transition metal to a carbonaceous material by contacting the carbonaceous material with an alcohol solution saturated with a transition metal salt; and (b) providing manganese oxide including the transition metal by contacting the carbonaceous material on which the transition metal is adsorbed with a manganese oxide precursor-aqueous solution.

In operation (a), the carbonaceous material is contacted with the alcohol solution saturated with the transition metal salt to adsorb the transition metal on the carbonaceous material.

The positive electrode including the carbonaceous material has a structure in which carbon paper is coated with porous carbon. In order to adsorb the transition metal on the carbonaceous material, the carbonaceous material is contacted with the alcohol solution saturated with the transition metal salt.

The alcohol solution of operation (a) may be a solution of a C1-C20 alcohol. For example, the alcohol solution may include at least one alcohol selected from the group consisting of a methanol solution, an ethanol solution, a propanol solution, and an isopropanol solution but is not limited thereto. In particular, the alcohol solution may be an ethanol solution.

The alcohol solution of operation (a) may further include water.

The transition metal salt of operation (a) may include at least one salt selected from the group consisting of zinc sulfate, zinc nitrate, zinc chloride, zinc acetate, cobalt sulfate, cobalt nitrate, cobalt chloride, cobalt fluoride, cobalt acetate, iron sulfate, iron nitrate, iron chloride, copper sulfate, copper nitrate, copper chloride, copper acetate, nickel sulfate, nickel nitrate, nickel chloride, nickel fluoride, and nickel acetate. In particular, the transition metal salt of operation (a) may be nickel sulfate, nickel nitrate, nickel chloride, nickel fluoride, or nickel acetate. More particularly, the transition metal salt may be nickel acetate.

In operation (b), the manganese oxide including the transition metal may be adsorbed by contacting the carbonaceous material on which the transition metal is adsorbed with the manganese oxide precursor-aqueous solution.

The manganese oxide precursor of operation (b) may be a manganese oxide including an alkali metal that, for example, may include at least one compound selected from the group consisting of LiMnO₄, NaMnO₄, and KMnO₄. In particular, the manganese oxide precursor may be KMnO₄. If the carbonaceous material on which the transition metal is adsorbed is contacted with the manganese oxide precursor-aqueous solution used as a strong oxidant, the manganese oxide precursor may be reduced so that the oxidation state of Mn is changed from 7+ to 4+, may be precipitated as a manganese dioxide (MnO₂) on the carbon surface, and may oxidize transition metal ions. In addition, an internal layered structure of the manganese oxide may be including the transition metal that is not oxidized or reduced.

The concentration of the manganese oxide precursor-aqueous solution may be in the range of about 0.0001 M to about 0.2 M. For example, the concentration of the manganese oxide precursor-aqueous solution may be in the range of about 0.05 M to about 0.1 M.

The carbonaceous material on which the transition metal is adsorbed may be contacted with the manganese oxide precursor-aqueous solution at a temperature in the range of about 50 to about 100° C. For example, the temperature may be in the range of about 50 to about 80° C.

If the concentration of the manganese oxide precursor-aqueous solution and the temperature are within the ranges described above, the positive electrode of the lithium air battery may maintain its morphology by quickly performing the formation of the positive electrode including the manganese oxide including the transition metal. However, the concentration and the temperature are not limited thereto and may vary according to reaction rates.

Then, the positive electrode including the manganese oxide including the transition metal may be dried. The drying may include heat-treating at a temperature in the range of about 100 to about 120° C. and may be performed in a vacuum.

Another embodiment provides a lithium air battery including a negative electrode in which lithium ions are intercalatable and deintercalatable; a nonaqueous electrolyte; and a positive electrode, wherein the positive electrode includes oxygen as a positive active material and a catalyst for a redox reaction of oxygen, wherein the catalyst is a manganese oxide including at least one transition metal selected from the group consisting of zinc (Zn), cobalt (Co), iron (Fe), copper (Cu), and nickel (Ni).

The negative electrode in which lithium ions are intercalatable and deintercalatable may be lithium metal, lithium metal-based alloys, or lithium intercalating compounds. The lithium metal-based alloys may include alloys of lithium with aluminum (Al), tin (Sn), magnesium (Mg), indium (In), calcium (Ca), titanium (Ti), and vanadium (V). The lithium intercalating compounds may be a carbonaceous material such as graphite. The negative electrode in which lithium ions are intercalatable and deintercalatable may also be lithium metal and a carbonaceous material. The negative electrode in which lithium ions are intercalatable and deintercalatable may also be lithium metal in consideration of characteristics of high capacity batteries.

The nonaqueous electrolyte may function as a medium for migration of ions involved in electrochemical reactions in the lithium air battery. In addition, the nonaqueous electrolyte may be an organic solvent that does not include water. Examples of the nonaqueous electrolyte may be carbonates, esters, ethers, ketones, organosulfur solvents, organophosphorus solvents, and aprotic solvents.

The positive electrode may use oxygen as the positive active material and may include the catalyst for a redox reaction of oxygen. The positive electrode including oxygen as the positive active material may be a conductive and/or porous carbonaceous material as described above, and the catalyst for a redox reaction of oxygen may be a noble metal catalyst, an oxide catalyst, or an organometallic catalyst such as cobalt phthalocyanine as described above.

The catalyst may include manganese oxide including at least one transition metal selected from the group consisting of zinc (Zn), cobalt (Co), iron (Fe), copper (Cu), and nickel (Ni).

Since the lithium air battery including the positive electrode including the manganese oxide including the transition metal may reduce any overcharge voltage (η_{chg}) by facilitating the evolution of oxygen during charging, stability of the catalyst, capacity, and energy efficiency of the lithium air battery may be greater than lithium air batteries including a positive electrode including a porous carbonaceous material without a catalyst or lithium air batteries including a positive electrode including a manganese oxide catalyst.

FIG. 3 schematically shows a structure of a lithium air battery 10 according to an embodiment of the present invention. Referring to FIG. 3, the lithium air battery 10 includes a negative electrode 13 in which lithium ions adjacent to a first current collector 12 are intercalatable and deintercalatable, a positive electrode 15 including oxygen as an active material formed in a second current collector 14, and an electrolyte 18 interposed between the negative electrode 13 and the positive electrode 15, wherein the positive electrode 15 includes a catalyst 17. A lithium ion conductive solid electrolyte membrane 16 may be interposed between the negative electrode 13 and the positive electrode 15, and a separator (not shown) may be disposed between the solid electrolyte membrane 16 and the positive electrode 15.

The first current collector 12 may be any current collector having conductivity. For example, copper (Cu), stainless steel, nickel (Ni), or the like may be used. For example, the first current collector 12 may have a thin film shape, a plate shape, a mesh shape, and a grid shape.

The negative electrode 13 in which lithium ions are intercalatable and deintercalatable may be lithium metal, lithium metal-based alloys, or lithium intercalating compounds as described above.

The negative electrode 13 in which lithium ions are intercalatable and deintercalatable may further include a binder. The binder may be polyvinylidene fluoride (PVdF), polytetrafluoroethylene (PTFE), or the like. The amount of the binder may be 30% by weight or less, but is not limited thereto. In particular, the amount of the binder may be in the range of about 1 to about 10% by weight.

Any porous current collector capable of functioning as a gas diffusion layer in which air is diffused and having conductivity may be used as the second current collector 14. For example, stainless steel, nickel (Ni), aluminum (Al), iron (Fe), titanium (Ti), carbon (C), or the like may be used. In addition, the second current collector 14 may have a thin film shape, a plate shape, a mesh shape, or a grid shape. In particular, the second current collector 14 may have a mesh shape. The mesh shape is suitable for the second current collector 14 due to high current collecting efficiency.

The positive electrode 15 including oxygen as an active material may further include another catalyst in addition to the catalyst 17 described above. For example, WC or WC-fused cobalt, CoWO₄, FeWO₄, NiS, WS₂, or the like may be used. For example, La₂O₃, Ag₂O, Ag, perovskite, spinel, or the like may also be used. The spinel crystal structure is an oxide represented by AB₂O₄, in which A is a +2 oxidation state metal ion such as magnesium (Mg), iron (Fe), nickel (Ni), manganese (Mn), and/or zinc (Zn), and B is a +3 oxidation state metal ion such as aluminum (Al), iron (Fe), chromium (Cr), and/or manganese (Mn). The perovskite crystal structure is an oxide of AXO₃, in which A is a +2 oxidation state metal ion such as calcium (Ca), strontium (Sr), lead (Pb), samarium (Sm) or europium (Eu); and X may be a +4 oxidation state metal such as titanium (Ti). All elements of this group have the same basic structure as XO₃ having octahedral structures connected to each other.

The positive electrode 15 including oxygen as an active material may further include a binder. The same type and amount of the binder as those described above with reference to negative electrode 13 may be used, and thus the descriptions thereof will be omitted herein.

The electrolyte 18 may be a nonaqueous electrolyte. The nonaqueous electrolyte may be an organic solvent that does not include water. Examples of the nonaqueous electrolyte may be carbonates, esters, ethers, ketones, organosulfur solvents, organophosphorus solvents, or aprotic solvents, as described above.

Examples of the carbonates available as the nonaqueous organic solvent may include dimethyl carbonate (DMC), diethyl carbonate (DEC), ethyl methyl carbonate (methyl ethyl carbonate, MEC, EMC), dipropyl carbonate (DPC), methylpropyl carbonate (MPC), ethylpropyl carbonate (EPC), ethylene carbonate (EC), propylene carbonate (PC), fluoroethylene carbonate (FEC), 1,2-butylene carbonate and trans-2,3-butylene carbonate. Examples of the esters available as the nonaqueous organic solvent may include methyl acetate, ethyl acetate, n-propyl acetate, methyl propionate, ethyl propionate, γ-butyrolactone, 5-decanolide, γ-valerolactone, dl-mevalonolactone, and γ-caprolactone. Examples of the ethers available as the nonaqueous organic solvent may include dibutyl ether, tetraglyme, diglyme, dimethoxyethane, 2-methyltetrahydrofuran, and tetrahydrofuran. An example of the ketones available as the nonaqueous organic solvent may be cyclohexanone. An example of the organosulfur solvent available as the nonaqueous organic solvent may include methanesulfonyl chloride and the like. An example of the organophosphorus solvent available as the nonaqueous organic solvent may include p-trichloro-n-dichlorophosphorylmonophosphazene and the like. Examples of the aprotic solvents may include nitriles, such as R—CN (wherein R is a straight, branched or cyclic C2-C20 hydrocarbon group, which may have a double-bonded aromatic ring or an ether bond); amides, such as dimethylformamide; dioxolanes, such as 1,3-dioxolane; and sulfolanes.

The nonaqueous organic solvent may be used alone. Alternatively, at least two of the nonaqueous organic solvents may be used in combination. In this case, the mixing ratio of the nonaqueous organic solvents may appropriately vary according to the designed performance of the battery, which may be known to one of ordinary skill in the art.

The nonaqueous solvent may include a lithium salt, and the lithium salt may be dissolved in the organic solvent to be a source of lithium ions in a battery, for example, to facilitate migration of lithium ions between the negative electrode 13 and lithium ion conductive solid electrolyte membrane 16. The lithium salt may include at least one salt selected from the group consisting of LiPF₆, LiBF₄, LiSbF₆, LiAsF₆, LiN(SO₂C₂F₆)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂), where x and y are respectively natural number, LiF, LiBr, LiCl, Lil and LiB(C₂O₄)₂, and lithium bis(oxalato) borate (LiBOB). The concentration of the lithium salt may be in the range of about 0.1 to about 2.0 M. When the concentration of the lithium salt is within this range, the electrolyte may have an appropriate conductivity and viscosity, and thus may exhibit excellent performance, allowing lithium ions to effectively migrate. The nonaqueous organic solvent may further include another metal salt such as AlCl₃, MgCl₂, NaCl, KCl, NaBr, KBr, and CaCl₂ in addition to the lithium salt.

In addition, the lithium ion conductive solid electrolyte membrane 16 may be disposed between the negative electrode 13 and the positive electrode 15. The lithium ion conductive solid electrolyte membrane 16 may function as a protective layer that inhibits a direct reaction between water contained in the aqueous electrolyte and lithium contained in the negative electrode 13. Examples of the lithium ion conductive solid electrolyte membrane 16 may be lithium ion conductive glass, lithium ion conductive crystals (ceramics or glass-ceramics), or an inorganic material including mixtures thereof. For chemical stability, the lithium ion conductive solid electrolyte membrane 16 may be an oxide.

The lithium ion conductive crystals may be Li_{1+x+y}(Al, Ga)ₓ(Ti, Ge)₂₋ₓSiP_{3-y}O₁₂ (0≦x≦1, 0≦y≦1, for example 0≦x≦0.4, 0≦y≦0.6, or 0.1≦x≦0.3, 0.1<y≦0.4). Examples of the lithium ion conductive glass-ceramics are lithium-aluminum-germanium-phosphate (LAGP), lithium-aluminum-titanium-phosphate (LATP), and lithium-aluminum-titanium-silicon-phosphate (LATSP). The lithium ion conductive solid electrolyte membrane may further include a polymer solid electrolyte component in addition to the glass-ceramic. The polymer solid electrolyte may be polyethylene oxide including a lithium salt, and the lithium salt may be LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, or the like.

In addition, a separator (not shown) may be disposed between the solid electrolyte membrane 16 and the positive electrode 15. The separator may be any separator having a composition which may be used in the lithium air battery. For example, a polymer non-woven fabric such as a polypropylene non-woven fabric or a polyphenylene sulfide non-woven fabric, a porous film of an olefin resin such as polyethylene or polypropylene, or a combination of at least two thereof may be used.

The term “air” used herein is not limited to atmosphere, and may include a composition of air including oxygen or pure oxygen gas. The wide definition of the term “air” may also be applied to, for example, the air battery, the air positive electrode, or the like.

The lithium air battery may be used for a lithium primary battery or a lithium secondary battery. In addition, the shape of the lithium air battery may be a coin type, a button type, a sheet type, a stack type, a cylindrical type, a panel type, or a cone shape, but is not limited thereto. The lithium air battery may also be used for a large battery used in an electrical vehicle.

Hereinafter, one or more embodiments of the present invention will be described in detail with reference to the following examples. However, these examples are not intended to limit the purpose and scope of the one or more embodiments of the present invention.

### EXAMPLES

### Preparation of Positive Electrode

### Preparation Example 1

### Manganese Oxide Including Nickel

An ethanol solution saturated with nickel acetate (Ni(CH₃COO)₂) was prepared at room temperature. A positive electrode including a carbonaceous material (hereinafter, referred to as ‘carbon electrode’, GDL 35BC produced by SGL) was immersed in the saturated ethanol solution for 5 minutes and taken out. Then, the carbon electrode was immersed in a 0.1 M KMnO₄ solution, heated to 75° C. and maintained at that temperature for 5 minutes. Then, the carbon electrode was dried in the air at 80° C. for 24 hours, and then dried at 120° C. for 120 minutes to obtain a positive electrode for a lithium air battery including 5 parts by weight of Ni_{0.1}Mn_{0.9}O₂ having an average particle diameter of 20 nm, and formed on the carbon electrode.

### Preparation Example 2

### Manganese Oxide Including Zinc

A positive electrode for a lithium air battery including 3.5 parts by weight of K_{0.1}Zn_{0.15}Mn_{0.85}O₂ was prepared in the same manner as in Example 1, except that zinc acetate (Zn(CH₃COO)₂) was used instead of nickel acetate (Ni(CH₃COO)₂).

### Preparation Example 3

### Manganese Oxide Including Cobalt

A positive electrode for a lithium air battery including 3.1 parts by weight of K_{0.26}CO_{0.03}Mn_{0.97}O₂ was prepared in the same manner as in Example 1, except that cobalt acetate (Co(CH₃COO)₂) was used instead of nickel acetate (Ni(CH₃COO)₂).

### Preparation Example 4

### Manganese Oxide Including Iron

A positive electrode for a lithium air battery including 5.2 parts by weight of K_{0.18}Fe_{0.12}Mn_{0.88}O₂ was prepared in the same manner as in Example 1, except that iron sulfate (FeSO₄) was used instead of nickel acetate (Ni(CH₃COO)₂).

### Preparation Example 5

### Manganese Oxide Including Copper

A positive electrode for a lithium air battery including 3.7 parts by weight of K_{0.23}Cu_{0.09}Mn_{0.91}O₂ was prepared in the same manner as in Example 1, except that copper acetate (Cu(CH₃COO)₂) was used instead of nickel acetate (Ni(CH₃COO)₂).

### Preparation of Battery

### Example 1

### Lithium Air Battery Including Manganese Oxide Including Nickel

A positive electrode, including manganese oxide including nickel prepared in Preparation Example 1 as a catalyst, was prepared. A lithium thin film was used as a negative electrode. Polypropylene (3501 produced by Celgard) was used as a separator interposed between the positive electrode and the negative electrode.

The lithium thin film negative electrode was put into a stainless steel case, the separator into which 1 M LiClO₄ was injected was disposed to face the negative electrode, and the positive electrode was disposed on the separator to face the negative electrode. Then, a stainless steel mesh was disposed on the positive electrode, and a pressing member via which air may be transferred to the positive electrode was disposed on the positive electrode to fix the cell to prepare a lithium air battery.

The case was partitioned into an upper portion that contacted the negative electrode and a lower portion that contacts the positive electrode. An insulating resin was interposed between the upper and lower portions to electrically insulate the positive electrode and the negative electrode from each other.

### Example 2

### Lithium Air Battery Including Manganese Oxide Including Zinc

A lithium air battery was prepared in the same manner as in Example 1, except that the positive electrode including the manganese oxide including zinc prepared in Preparation Example 2 was used.

### Example 3

### Lithium Air Battery Including Manganese Oxide Including Cobalt

A lithium air battery was prepared in the same manner as in Example 1, except that the positive electrode including the manganese oxide including cobalt prepared in Preparation Example 3 was used.

### Example 4

### Lithium Air Battery Including Manganese Oxide Including Iron

A lithium air battery was prepared in the same manner as in Example 1, except that the positive electrode including the manganese oxide including iron prepared in Preparation Example 4 was used.

### Example 5

### Lithium Air Battery Including Manganese Oxide Including Copper

A lithium air battery was prepared in the same manner as in Example 1, except that the positive electrode including the manganese oxide including copper prepared in Preparation Example 5 was used.

### Comparative Example 1

### Lithium Air Battery Not Including Catalyst

A lithium air battery was prepared in the same manner as in Example 1, except that the positive electrode including a carbonaceous material without a catalyst (GDL 35BC produced by SGL) was used.

### Comparative Example 2

### Lithium Air Battery Including Manganese Oxide

A lithium air battery was prepared in the same manner as in Example 1 by using a positive electrode for a lithium air battery including 3 parts by weight of MnO₂ having an average particle diameter of 20 nm and formed on the carbon electrode prepared in the same manner as in Preparation Example 1, except that an ethanol solution was used instead of the ethanol solution saturated with nickel acetate (Ni(CH₃COO)₂).

### Evaluation Example 1

### Evaluation of Charge/Discharge Characteristics

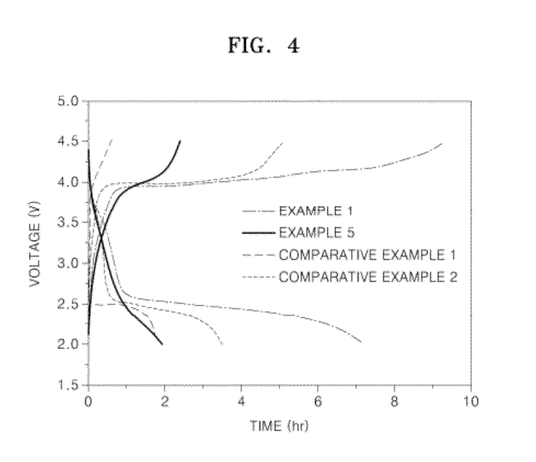

Lithium air batteries manufactured according to Examples 1 and 5 and Comparative Example 2 were discharged with a constant current of 0.2 mA/cm² at 25° C. at 1 atm until the voltage thereof reached 2 V (vs. Li) and charged with the same current until the voltage thereof reached 4.5 V. The lithium air battery manufactured according to Comparative Example 1 was discharged with a constant current of 0.2 mA/cm² until the voltage thereof reached 2 V (vs. Li) and charged with the same current until the voltage thereof reached 4.6 V. The results of the charge/discharge are shown in Table 1 and FIG. 4, with the rising curves representing charge and the falling curves representing discharge. Discharge capacity and charge capacity are defined as a discharge capacity and a charge capacity per unit weight of carbon. Energy efficiency during charging/discharging (round-trip efficiency) is calculated using Equation 1 below.

Round-trip efficiency(%)=[average discharge voltage of 5^{th} cycle/average charge voltage]×100 Equation 1

The average discharge voltage and average charge voltage were calculated by integrating voltage change with respect to a charge/discharge time with time in the charge/discharge curve of FIG. 4 and dividing the result by a total charge/discharge time.

TABLE 1

| | Discharge | Charge | |
|---|---|---|---|
| | capacity | capacity | Energy efficiency (%) |
| | (mAh/g) | (mAh/g) | (Round-trip efficiency) |
| Example 1 | 344 | 441 | 62 |
| Example 5 | 92 | 114 | 70 |
| Comparative | 84 | 37 | 58 |
| Example 1 | | | |
| Comparative | 166 | 243 | 63 |
| Example 2 | | | |

Referring to the result of Table 1, the discharge capacities of the positive electrode for a lithium air battery, which included the manganese oxide including nickel manufactured according to Example 1 were greater than the discharge capacity of the positive electrodes for lithium air batteries, which did not include a catalyst and included the manganese oxide manufactured according to Comparative Examples 1 and 2.

In addition, referring to FIG. 4, the round-trip efficiencies of the positive electrode of the lithium air battery, which included the manganese oxide including copper manufactured according to Example 5, were greater than the round-trip efficiencies of the positive electrode, which did not include a catalyst as manufactured according to Comparative Example 1 and the positive electrode including only manganese oxide as manufactured according to Comparative Example 2. The improvement in the discharge capacities and round-trip efficiencies of Examples 1 and 5 was due to the manganese oxide catalyzed by nickel or copper as shown in FIG. 4.

As described above, according to one or more of the above embodiments of the present invention, the lithium air battery may reduce overvoltage by using a manganese oxide including at least one transition metal selected from the group consisting of zinc (Zn), cobalt (Co), iron (Fe), copper (Cu), and nickel (Ni) as a catalyst for a positive electrode during charging to have high charge/discharge capacity, thereby improving energy efficiency and capacity.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A positive electrode for a lithium air battery comprising:
oxygen as a positive active material; and
a catalyst for a redox reaction of oxygen,
wherein the catalyst comprises manganese oxide including at least one transition metal selected from the group consisting of zinc (Zn), cobalt (Co), iron (Fe), copper (Cu), and nickel (Ni).

2. The positive electrode for the lithium air battery of claim 1, wherein the manganese oxide including the transition metal is represented by Formula 1 below:
MₓMn_{y}O_{z} Formula 1
where M comprises at least one selected from the group consisting of Zn, Co, Fe, Cu, and Ni, and
0<x<1, 0<y<1, 0<z<5, and x+y=1.

3. The positive electrode for the lithium air battery of claim 1, wherein the catalyst comprises manganese oxide including nickel (Ni).

4. The positive electrode for the lithium air battery of claim 2, wherein the manganese oxide including the transition metal comprises a mixed oxide selected from the group consisting of nickel manganese oxide (NiₓMn_{y}O_{z}), nickel zinc manganese oxide ((NiZn)ₓMn_{y}O_{z}), nickel cobalt manganese oxide ((NiCo)ₓMn_{y}O_{z}), nickel iron manganese oxide ((NiFe)ₓMn_{y}O_{z}), nickel copper manganese oxide ((NiCu)ₓMn_{y}O_{z}), nickel zinc cobalt manganese oxide ((NiZnCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), nickel cobalt iron copper manganese oxide ((NiCoFeCu)ₓMn_{y}O_{z}), and nickel zinc cobalt iron copper manganese oxide ((NiZnCoFeCu)ₓMn_{y}O_{z}).

5. The positive electrode for the lithium air battery of claim 3, wherein the manganese oxide including nickel (Ni) is represented by Formula 2 below:
NiₓMn_{y}O₂ Formula 2
where 0<x<1, 0<y<1, and x+y=1.

6. The positive electrode for the lithium air battery of claim 1, wherein the catalyst comprises an amorphous manganese oxide including a transition metal.

7. The positive electrode for the lithium air battery of claim 1, wherein the catalyst comprises manganese oxide including a transition metal and has an average particle diameter in the range of about 10 to about 70 nm.

8. The positive electrode for the lithium air battery of claim 1, wherein the amount of the catalyst is in the range of about 0.1 to about 80% by weight based on the total weight of the positive electrode.

9. The positive electrode for the lithium air battery of claim 1, further comprising a carbonaceous material and a binder.

10. The positive electrode for the lithium air battery of claim 9, wherein the positive electrode comprises about 0.1 to about 77.1% by weight of the catalyst, about 20 to about 97% by weight of the carbonaceous material, and about 2.9 to about 20% by weight of the binder based on a total weight of the positive electrode.

11. A method of preparing a positive electrode for a lithium air battery, the method comprising:
(a) providing a transition metal salt on a carbonaceous material by contacting the carbonaceous material with an alcohol solution saturated with the transition metal salt; and
(b) providing manganese oxide including the transition metal by contacting the carbonaceous material on which the transition metal is provided with a manganese oxide precursor-aqueous solution.

12. The method of claim 11, wherein the alcohol solution of operation (a) is a solution of a C1-C20 alcohol.

13. The method of claim 11, wherein the alcohol solution of operation (a) further comprises water.

14. The method of claim 11, wherein the transition metal salt of operation (a) is at least one salt selected from the group consisting of zinc sulfate, zinc nitrate, zinc chloride, zinc acetate, cobalt sulfate, cobalt nitrate, cobalt chloride, cobalt fluoride, cobalt acetate, iron sulfate, iron nitrate, iron chloride, copper sulfate, copper nitrate, copper chloride, copper acetate, nickel sulfate, nickel nitrate, nickel chloride, nickel fluoride, and nickel acetate.

15. The method of claim 14, wherein the transition metal salt of operation (a) is at least one selected from the group consisting of nickel sulfate, nickel nitrate, nickel chloride, nickel fluoride, and nickel acetate.

16. The method of claim 11, wherein the manganese oxide precursor of operation (b) is at least one oxide selected from the group consisting of LiMnO₄, NaMnO₄ and KMnO₄.

17. A lithium air battery comprising:
a negative electrode in which lithium ions are intercalatable and deintercalatable;
a nonaqueous electrolyte; and
a positive electrode,
wherein the positive electrode further comprises:
oxygen as a positive active material; and
a catalyst for a redox reaction of oxygen,
wherein the catalyst comprises manganese oxide including at least one transition metal selected from the group consisting of zinc (Zn), cobalt (Co), iron (Fe), copper (Cu), and nickel (Ni).

18. The lithium air battery of claim 17, wherein the manganese oxide including the transition metal is represented by Formula 1 below:
MₓMn_{y}O_{z} Formula 1
where M comprises at least one transition metal selected from the group consisting of Zn, Co, Fe, Cu, and Ni, and
0<x<1, 0<y<1, 0<z<5, and x+y=1.

19. The lithium air battery of claim 17, wherein the catalyst is manganese oxide including nickel (Ni).

20. The lithium air battery of claim 18, wherein the manganese oxide including the transition metal is a mixed oxide selected from the group consisting of nickel manganese oxide (NiₓMn_{y}O_{z}), nickel zinc manganese oxide ((NiZn)ₓMn_{y}O_{z}), nickel cobalt manganese oxide ((NiCo)ₓMn_{y}O_{z}), nickel iron manganese oxide ((NiFe)ₓMn_{y}O_{z}), nickel copper manganese oxide ((NiCu)ₓMn_{y}O_{z}), nickel zinc cobalt manganese oxide ((NiZnCo)ₓMn_{y}O_{z}), nickel iron cobalt manganese oxide ((NiFeCo)ₓMn_{y}O_{z}), nickel iron copper manganese oxide ((NiFeCu)ₓMn_{y}O_{z}), nickel cobalt iron copper manganese oxide ((NiCoFeCu)ₓMn_{y}O_{z}), and nickel zinc cobalt iron copper manganese oxide ((NiZnCoFeCu)ₓMh_{y}O_{z}).

21. The lithium air battery of claim 19, wherein the manganese oxide including nickel (Ni) is represented by Formula 2 below:
NiₓMn_{y}O₂ Formula 2
where 0<x<1, 0<y<1, and x+y=1.

22. The lithium air battery of claim 17, wherein the positive electrode is amorphous manganese oxide including a transition metal.

23. The lithium air battery of claim 17, wherein the positive electrode comprises about 0.1 to about 80% by weight of the catalyst based on the total weight of the positive electrode.
